(19) United States
(12) Patent Application Publication
(10) Pub. No.: US 2012/0086817 A1
(43) Pub. Date: Apr. 12, 2012

(54) DIGITAL CAMERA

(75) Inventor: Yasuhiro YAMAMOTO, Tokyo (JP)

(73) Assignee: HOYA CORPORATION, Tokyo (JP)

(21) Appl. No.: 13/252,508

(22) Filed: Oct. 4, 2011

(30) Foreign Application Priority Data
Oct. 7, 2010 (JP) 2010-227486

(51) Int. Cl. H04N 5/225

(52) U.S. Cl. 348/207.1; 348/E05.024

(57) ABSTRACT

A digital camera is provided that includes an imaging module and a first wireless communication module. The first wireless communication module is used to perform radio communication with a monitor device separated from a camera body. A volume of data being transferred per unit time is reduced compared to a volume of moving-image data transferred via wired communication to display the moving image, when moving-image data obtained by the imaging module being transferred to the monitor device uses the first wireless communication module.

### BACKGROUND OF THE INVENTION

1. Field of the Invention

The present invention relates to a digital camera that can display a through-the-lens image and specifically to a digital camera with a detachable monitor device.

2. Description of the Related Art

In general, digital cameras are provided with a monitor that is used to display a captured image or a through-the-lens image (a live preview image). In certain such cameras a monitor is configured to be rotatable with respect to the camera body via a rotating mechanism, such as a hinge. Further, a digital camera with a monitor being made detachable from the camera body is also provided in Japanese Unexamined Patent Publication No. 2000-261697.

### SUMMARY OF THE INVENTION

It is advantageous if the digital camera disclosed in the above patent document can display a through-the-lens image or recorded video on the monitor even when the monitor is detached from the camera body. However, the wireless frequency band assigned to such data transmission does not have a sufficient data transfer rate to transmit the above-mentioned moving images. Therefore, the through-the-lens image and video image cannot be displayed on the monitor when the monitor is detached from the camera body.

Therefore, one aspect of the present invention is to enable the display of a moving image on a detachable monitor device by transmitting the moving image data from the camera body via a wireless transmission.

According to the present invention, a digital camera is provided with an imaging module and a first wireless communication module.

The first wireless communication module is used to perform radio communication with a monitor device separated from a camera body. The volume of data transferred per unit time that is required to display a moving image is reduced compared to the volume of moving-image data transferred via wired or cable communication when the first wireless communication module is used to transfer moving-image data from the imaging module to the monitor device.

According to another aspect of the invention, a digital camera is provided with a camera body, a monitor device, a detector and a controller.

The camera body includes an imaging module and a first wireless communication module. The monitor device is detachable from the camera body and it includes a monitor (a screen) and a second wireless communication module complemental to the first wireless communication module. The detector determines whether the monitor device is attached to or detached from the camera body and the controller changes a volume of data transferred per unit time in accordance with the determination of the detector.

### BRIEF DESCRIPTION OF THE DRAWINGS

The objects and advantages of the present invention will be better understood from the following description, with reference to the accompanying drawings in which:

FIG. 1 is a block diagram schematically illustrating the general structure of a digital camera of an embodiment of the present invention;

FIG. 2 is a flowchart of a moving-image data transmission operation; and

FIG. 3 is a connection diagram of connector terminals of the present embodiment.

### DESCRIPTION OF THE PREFERRED EMBODIMENTS

The present invention is described below with reference to the embodiments shown in the drawings.

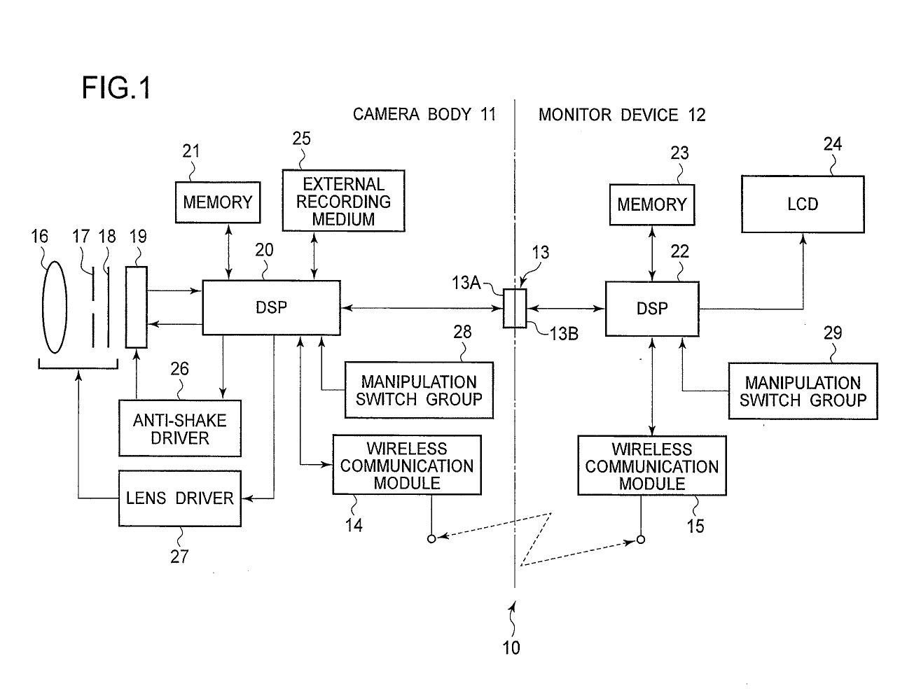

FIG. 1 is a block diagram schematically illustrating the general structure of a digital camera to which an embodiment of the present invention is applied.

The digital camera 10 includes a camera body 11 and a monitor device 12. The monitor device is configured to be detachable from the camera body 11. When the monitor device 12 is attached to the camera body 11, the camera body 11 and the monitor device 12 are electrically connected to each other via a connector 13, which is comprised of a pair of connector halves 13A and 13B. Namely, moving image data of a through-the-lens image, image data of a still image or control signals are transmitted/received between the camera body 11 and the monitor device 12 via the connector 13. On the other hand, when the monitor device 12 is detached from the camera body 11, the above-mentioned data and signals are transmitted/received through wireless communications by wireless communication modules 14 and 15 provided on each side of the camera body 11 and monitor device 12.

In the camera body 11, an image sensor 19 captures an object image through a lens system 16, an aperture 17 and a shutter 18. The image captured by the image sensor 19 is fed to a digital signal processor (DSP) 20 where predetermined image processing is performed. Further, the image data is temporarily stored in memory 21 and also fed to a digital signal processor (DSP) 22 of the monitor device via the connector 13 or the wireless communication modules 14 and 15. The image data received by the digital signal processor (DSP) 22 is stored in memory 23 of the monitor device 12. At the same time, the received image may also be displayed on an LCD or monitor 24 of the monitor device 12. Note that the image stored in the memory 21 can also be recorded onto an external recording medium 25, such as a memory card or the like, if desired.

Further, the camera body 11 of the present embodiment is configured with an anti-shake mechanism, which is driven by an anti-shake driver 26, to provide shake reduction or image stabilization functionality. In the example of FIG. 1, a sensor-shift type is chosen as the anti-shake mechanism, however, a lens-based type or any other type of image stabilization system or module may also be employed.

In the present embodiment, the optical system including the lens system 16, aperture 17, shutter 18 and so on, is controlled by a lens driver 27. Further, the anti-shake driver 26 and the lens driver 27 are controlled by the digital signal processor 20. Manipulation switch groups 28 and 29 provided on each of the camera body 11 and the monitor device 12 are connected to the digital signal processors (DSPs) 20 and 22, respectively. Each of the digital signal processors (DSPs) 20 and 22 performs various types of processes based on the manipulation of switches in the manipulation switch groups 28 and 29. Note that instead of or in addition to the manipulation switch group 29, a touchscreen may be applied to the LCD 24.

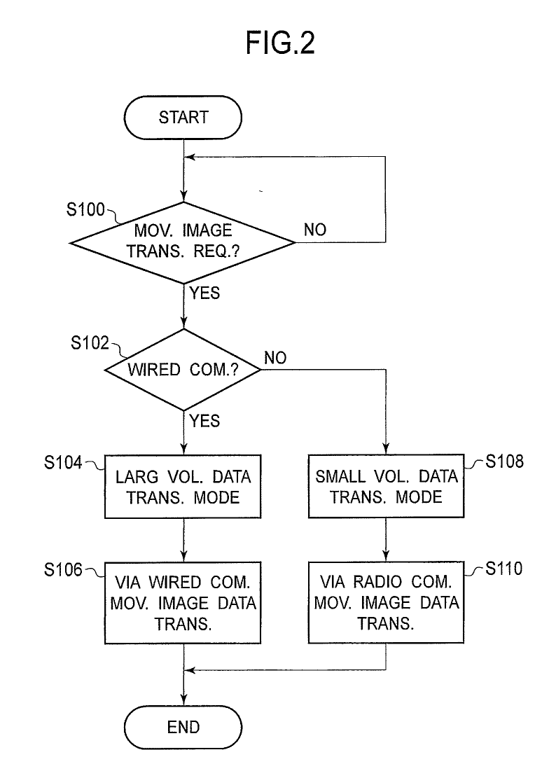

With reference to the flowchart of FIG. 2, a moving-image data transmission operation carried out in the digital camera 10 of the present embodiment will be explained. Note that the moving-image data transmission operation of FIG. 2 is repeatedly carried out by the digital signal processor (DSP) 20 of the camera body 11 at a predetermined time interval.

Recently, the number of pixels on the image sensors of digital cameras has been increasing. The resolution of a through-the-lens image (a live preview image) obtained by the image sensor 19 of the digital camera 10 may employ the VGA computer display standard (640*480 pixels). However, since a frequency band for the radio communication is limited, the data transfer rate is also limited. For example, an effective data transfer rate for a wireless local network employing IEEE802.11n standards is below 3 MB/s while VGA images of 30 fps requires 9.2 MB/s.

Accordingly, in the moving-image data transmission operation of the present embodiment, such as when transmitting the through-the-lens image and the like, the volume of data that is transferred per unit time is accommodated in accordance to whether the monitor device 12 is electrically connected to the camera body 11 through the connector 13 and a wired communication is used for the data transmission, or whether the monitor device 12 is detached from the camera body 11 and a radio communication is used for the data transmission.

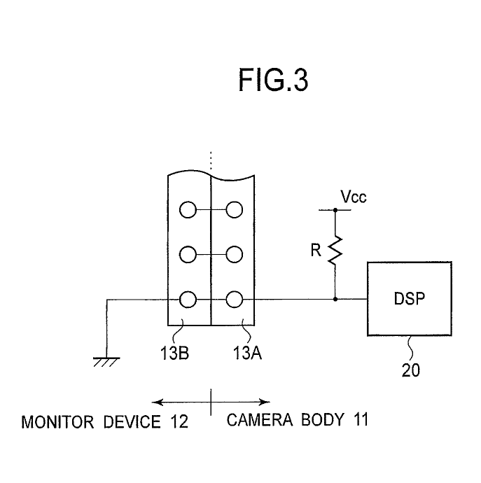

In Step S100, whether or not the moving-image data transmission has been requested is determined. When it is determined that the data transmission has been requested, whether or not the monitor device (the LCD unit) 12 is attached to the camera body 11 is determined in Step S102. Namely, whether the data transmission will be carried out via the wired communication or the radio communication is determined. Incidentally, the method for detecting the attachment of the monitor device 12 to the camera body 11 will be detailed later with reference to FIG. 3.

When the monitor device 12 is attached to the camera body 11 and thus it is determined in Step S102 that the data transmission will be carried out via the wired communication, a large volume data transmission mode is selected in Step S104. Further, image data of relatively high resolution are transmitted to the monitor device 12 via the lines wired through the connector 13 at a normal frame rate until this moving-image data transmission operation ends. For example, VGA images are transferred at 30 fps via the wires from the digital signal processor (DSP) 20 of the camera body 11 to the digital signal processor (DSP) 22 of the monitor device 12 and in turn displayed on the LCD 24.

On the other hand, when the monitor device 12 is detached from the camera body 11 and thus it is determined that the data transmission will be carried out by the radio communication in Step S102, a small volume data transmission mode is selected in Step S108. Further, in Step S110, the image data transmission from the camera body to the monitor device 12 is carried out via radio communication between the wireless modules 14 and 15 in the small volume data transmission mode until this moving-image data transmission operation ends.

In the small volume data transmission mode, the image data may be transferred after their resolution has been altered, such that the resolution of the image is reduced to relatively low resolution and the reduced image data are transferred to the monitor device 12 at a normal frame rate. Alternatively, the resolution may be maintained while the frame rate is reduced to a relatively low rate or the moving image data may be compressed to a relatively high compression ratio. Further, these methods can also be combined together, especially when Bluetooth, which has a relatively narrow bandwidth, is used.

When reducing the resolution, for example reducing the image data from VGA (640*480 pixels) to QVGA (320*240 pixels), the moving image data is transferred at 30 fps. Namely, QVGA images are displayed on the LCD 24 at 30 fps. Further, when maintaining the resolution while reducing the frame rate, for example maintaining the resolution at VGA and reducing the frame rate from 30 fps to 10 fps, VGA images are displayed on the LCD 24 at 10 fps.

With reference to FIG. 3, structures for detecting the attachment of the monitor device 12 in the present embodiment will be explained. In the present embodiment, the attachment of the monitor device 12 is detected through a terminal connection in the connector 13, and thereby whether the data transmission is carried out by the wired communication or the radio communication is determined.

FIG. 3 schematically shows the connection of terminals in the connector 13, which is used for detection of the attachment status of the monitor device 12. Although there are a number of terminals provided in the connector 13, only three of them are described in FIG. 3 in this example. In FIG. 3, the connector half 13B of the monitor device 12 is connected to the connector half 13A of the camera body 11.

A terminal of the connector half 13B that is used to detect the attachment of the monitor device 12 to the camera body 11 is connected to the ground while the voltage of the complementary terminal of the connector half 13A of the camera body 11 is pulled up via a pull-up resistor R connected to a terminal of the digital signal processor (DSP) 20 that is assigned to the above detection. Namely, when the monitor device 12 is detached from the camera body 11 and the connector halves 13A and 13B are disconnected, the voltage of the detection terminal of the digital signal processor (DSP) 20 is kept high. On the other hand, when the monitor device 12 is attached to the camera body 11 and the connector halves 13A and 13B are connected, the detection terminal of the digital signal processor (DSP) 20 is connected to the ground and the voltage level of the detection terminal is changed to low. Namely, the digital signal processor (DSP) 20 determines the attachment status of the monitor device 12 by determining whether the voltage of the detection terminal is high or low.

As described above, according to the present embodiment, in which the digital camera is configured with the detachable monitor device, the moving image data can be transferred from the camera body to the monitor device even when the monitor device is detached from the camera body.

Note that the digital camera in this embodiment may include either a digital still camera or a digital video camera.

Further, although the monitor device in the present embodiment is detachable from the camera body, the present invention may also be applied to a system that transmits moving image data by radio communication from a digital camera to a monitor or display device that may also be used independently from the digital camera configured with radio communication ability and an integrated monitor. In such case the digital camera may be provided with a monitor integrated with the camera body, and the transmission of the moving image data via radio communication to the remote monitor device may be chosen by a user selecting such mode. The data volume transferred per unit time is reduced in this radio communication compared to a situation when a moving image is displayed on the monitor integrated with the camera body.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2010-227486 (filed on Oct. 7, 2010), which is expressly incorporated herein, by reference, in its entirety.

1. A digital camera, comprising:
an imaging module;
a first wireless communication module that is used to perform radio communication with a monitor device separated from a camera body; and
a volume of data transferred per unit time being reduced compared to a volume of moving-image data transferred via wired communication to display the moving-image, when moving-image data obtained by said imaging module being transferred to said monitor device via said first wireless communication module.

2. The digital camera as in claim 1, wherein said camera body includes said imaging module, a first connector half and said first wireless communication module;
said monitor device includes a monitor, a second connector half connectable to said first connector half and a second wireless communication module capable of being communicable with said first wireless communication module; and said monitor device being attachable to and detachable from said camera body; and
the volume of data transferred per unit time is reduced compared to the volume of moving-image data transferred to said monitor device by said wired communication through said first and second connector halves being coupled together, when the moving-image data are transferred to said monitor device via said first and second wireless communication modules.

3. The digital camera as in claim 1, wherein whether to use said wired communication or said radio communication for transferring the moving-image data is determined by detecting a connection between said first and second connector halves.

4. The digital camera as in claim 1, wherein the reduction of the volume of data transferred per unit time comprises a reduction in the resolution of the moving image data that will be transferred.

5. The digital camera as in claim 1, wherein the reduction of the volume of data transferred per unit time comprises a reduction in the frame rate of the moving image data that will be transferred.

6. The digital camera as in claim 1, wherein the reduction of the volume of data transferred per unit time comprises an increase in the compression rate of the moving image data that will be transferred.

7. A digital camera, comprising:
a camera body that includes an imaging module, a first wireless communication module, a detector and a controller; and
a monitor device that is detachable from said camera body and that includes a monitor and a second wireless communication module complemental to said first wireless communication module;
said detector determines whether said monitor device is attached to or detached from said camera body and said controller changes a volume of data transferred per unit time in accordance with the determination of said detector.

8. The digital camera as in claim 7, wherein said controller reduces the volume of data transferred per unit time when said detector determines that said monitor device is detached from said camera body.
